(19) United States
(12) Patent Application Publication
(10) Pub. No.: US 2013/0250131 A1
(43) Pub. Date: Sep. 26, 2013

(54) IMAGE EVALUATING DEVICE, IMAGE EVALUATING METHOD, IMAGE EVALUATING SYSTEM, AND PROGRAM

(71) Applicant: FUJIFILM CORPORATION, Tokyo (JP)

(72) Inventors: Kei YAMAJI, Tokyo (JP); Yukita GOTOHDA, Tokyo (JP)

(73) Assignee: FUJIFILM CORPORATION, Tokyo (JP)

(21) Appl. No.: 13/778,198

(22) Filed: Feb. 27, 2013

(30) Foreign Application Priority Data
Mar. 26, 2012 (JP) 2012-068716

(51) Int. Cl. H04N 5/232; G06F 3/00

(52) U.S. Cl. CPC H04N 5/23229; G06F 3/005
USPC 348/207.1; 348/231.2

(57) ABSTRACT

An image evaluating device includes an information acquiring unit that acquires history information of a user communication terminal having a camera function, an image storage unit that stores images at least a part of which is captured by the use of the camera function of the user communication terminal, and an image evaluating unit that calculates evaluation values of the respective images stored in the image storage unit based on the history information acquired by the information acquiring unit.

### BACKGROUND OF THE INVENTION

The present invention relates to an image evaluating device, an image evaluating method, an image evaluating system, and a program for evaluating a degree of importance of an image for a user who owns the image.

There is a need for evaluating a degree of importance of an image in a case of preparing a photo book, using a WEB service such as an SNS (Social Networking Service), personally archiving images, and the like. Meanwhile, for example, a technique of measuring a degree of intimacy of a call partner with a user himself (or herself) from a call history and a technique of deciding a degree of importance of an image by analyzing the image have been conventionally known.

For example, JP 2011-43939 A discloses a communication device that identifies a communication partner, decides a degree of intimacy with the communication partner on the basis of communication history information, determines an image to be inserted into a document on the basis of the decision of the degree of intimacy and image information correlated with the degree of intimacy, inserts the determined image into the document, and transmits the document to the communication partner.

JP 2009-135616 A discloses a communication terminal that recognizes a face of a person included in an image on the basis of image data, decides a degree of intimacy with a person of communication destination on the basis of communication history information stored in correlation with information of the person of the communication destination, and corrects the recognition result on the basis of the decided degree of intimacy.

JP 2007-129609 A discloses a communication terminal device that collects and stores communication history information, registers communication address information of communication partners and image information representing the communication partners, displays images representing the registered communication partners on a display screen, and determines arrangement positions of the images representing the communication partners on the basis of the communication history information with the respective communication partners.

JP 2010-140069 A discloses an image processing apparatus that calculates a relational depth value representing a degree of relational depth between a specific person and a second person on the basis of an appearance frequency of the second person or a third person in contents including the specific person and appearance frequencies of the second person and the third person in contents not including the specific person, and determines the order of priority of the second person associated with the specific person on the basis of the relational depth value.

### SUMMARY OF THE INVENTION

However, JP 2011-43939 A merely discloses that an image corresponding to the degree of intimacy is inserted into a document and the document is transmitted to a communication partner, JP 2009-135616 A merely discloses that the recognition result of a face of a person included in an image is corrected depending on the degree of intimacy with a person of communication destination, and JP 2007-129609 A merely discloses that the arrangement positions of images representing communication partners are changed on the basis of the communication history information. These techniques do not evaluate a degree of importance of an image depending on the degree of intimacy.

On the other hand, JP 2010-140069 A discloses that the order of priority of a person is determined on the basis of the degree of intimacy corresponding to the appearance frequency of the person included in contents. However, in JP 2010-140069 A, history information is not used, unlike in JP 2011-43939 A, JP 2009-135616 A and JP 2007-129609 A. Accordingly, it is not clear whether a user and another person are actually intimate with each other.

An object of the present invention is to solve the above-mentioned prior art problems and to provide an image evaluating device, an image evaluating method, an image evaluating system, and a program which can accurately evaluate a degree of importance of an image for a user who owns the image.

In order to achieve the above-mentioned object, according to an aspect of the invention, there is provided an image evaluating device comprising: an information acquiring unit that acquires history information of a user communication terminal having a camera function; an image storage unit that stores images at least a part of which is captured by the use of the camera function of the user communication terminal; and an image evaluating unit that calculates evaluation values of the respective images stored in the image storage unit based on the history information acquired by the information acquiring unit.

According to another aspect of the invention, there is provided an image evaluating system comprising:

a user communication terminal; and

the above-mentioned image evaluating device that is connected to the user communication terminal through a network.

According to still another aspect of the invention, there is provided a user communication terminal having a camera function, comprising: an information acquiring unit that acquires history information of the user communication terminal; an image storage unit that stores images at least a part of which is captured by the use of the camera function of the user communication terminal; an image evaluating unit that calculates evaluation values of the respective images stored in the image storage unit based on the history information acquired by the information acquiring unit; and an application executing unit that executes an application using the images stored in the image storage unit, wherein the application executing unit preferentially selects and uses an image having a high evaluation value based on the evaluation values of the respective images calculated by the image evaluating unit.

According to yet another aspect of the invention, there is provided an image processing server connected to a user communication terminal having a camera function through a network, comprising: an information acquiring unit that acquires history information of the user communication terminal; an image storage unit that stores images at least a part of which is captured by the use of the camera function of the user communication terminal; an image evaluating unit that calculates evaluation values of the respective images stored in the image storage unit based on the history information acquired by the information acquiring unit; and an application executing unit that executes an application using the images stored in the image storage unit, wherein the application executing unit preferentially selects and uses an image having a high evaluation value based on the evaluation values of the respective images calculated by the image evaluating unit.

According to still yet another aspect of the invention, there is provided an image evaluating method comprising: an information acquiring step of acquiring history information of a user communication terminal having a camera function; an image storing step of storing images at least a part of which is captured by the use of the camera function of the user communication terminal; and an image evaluating step of calculating evaluation values of, the respective images stored in the image storing step based on the history information acquired in the information acquiring step.

According to a further aspect of the invention, there is provided a non-transitory computer-readable recording medium having recorded thereon a program for causing a computer to perform the respective steps of the above-mentioned image evaluating method.

In accordance with the invention, the evaluation value of an image stored in the image storage unit is calculated by using information of a user communication terminal such as history information or setting information, and therefore, it is possible to accurately evaluate the degree of importance of an image owned by a user.

### BRIEF DESCRIPTION OF THE DRAWINGS

FIG. 1 is a conceptual diagram showing the configuration of an image evaluating system according to an embodiment of the invention.

FIG. 2 is a block diagram showing the configuration of the image processing server shown in FIG. 1.

FIG. 3 is a flowchart showing the operation of the image processing server shown in FIGS. 1 and 2.

FIG. 4 is a conceptual diagram showing an example of a screen for editing layout data of an electronic photo album in a personal computer.

### DETAILED DESCRIPTION OF THE INVENTION

Hereinafter, an image evaluating device, an image evaluating method, an image evaluating system, and a program according to the invention will be described in detail with reference to preferred embodiments of the invention shown in the accompanying drawings.

FIG. 1 is a conceptual diagram showing the configuration of an image evaluating system according to an embodiment of the invention. The image evaluating system 10 shown in the drawing serves to evaluate a degree of importance of an image for a user who owns the image (hereinafter, also referred to as a user image), which is uploaded through a network 18 such as Internet, and the system 10 comprises a user communication terminal 12, an image processing server (image evaluating device) 14, and a PC (Personal Computer) 16.

The user communication terminal 12 is used by a user of the image evaluating system 10 and is a mobile terminal such as a mobile phone or a smartphone. In addition to a camera function and a GPS (Global Positioning System) function, the user communication terminal 12 has a communication function for uploading or downloading information of the user communication terminal 12 such as history or setting information and images captured through the use of the camera function or the like by the user to or from the image processing server 14 through the network 18.

Here, the history information of the user communication terminal 12 includes information such as an e-mail transmission and reception history, a call outgoing and incoming history, an image viewing history, an act history using the GPS function or the like (history of the position information acquired by the use of the GPS function of the user communication terminal 12), and an application use history. The setting information of the user communication terminal 12 includes setting information such as call rejection information and e-mail rejection information.

The information of the user communication terminal 12 such as the history or setting information is stored in a memory of the user communication terminal 12. The user communication terminal 12 uploads the information such as the history or setting information to the image processing server 14, for example, in the form of log information. At the time of uploading, it is preferable that the log information be encrypted.

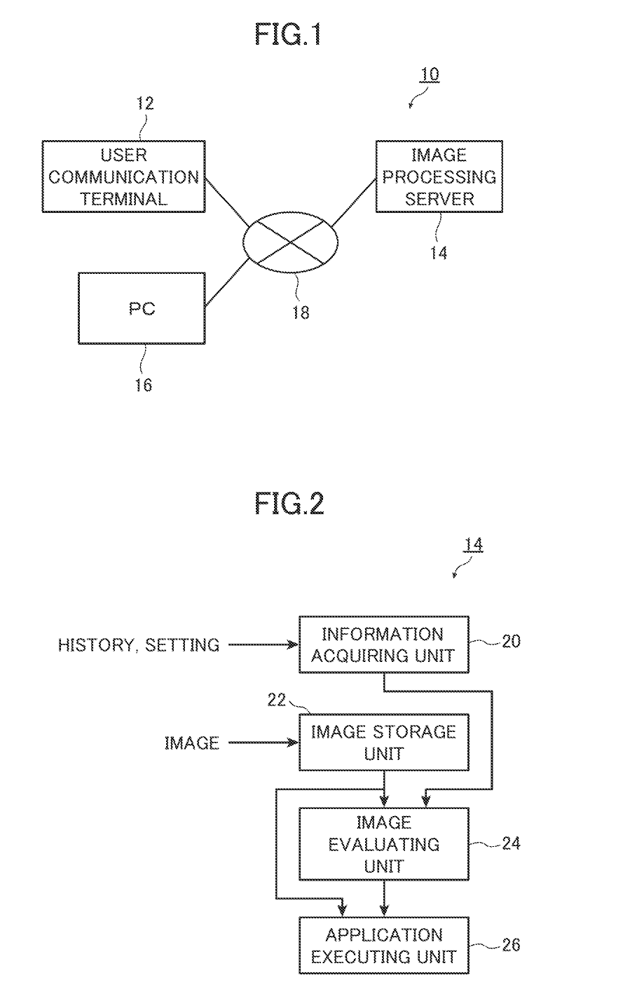

Subsequently, the image processing server 14 evaluates a degrees of importance of the respective user images similarly uploaded on the basis of the information of the user communication terminal 12 such as the history or setting information uploaded from the user communication terminal 12, and preferentially selects an image having a high degree of importance on the basis of the evaluation values for use in applications. As shown in FIG. 2, the image processing server 14 comprises an information acquiring unit 20, an image storage unit 22, an image evaluating unit 24, and an application executing unit 26.

The information acquiring unit 20 acquires the information of the user communication terminal 12 such as the history or setting information uploaded from the user communication terminal 12 through the network 18.

The image storage unit 22 stores user images (that is, digital image data) uploaded from the user communication terminal 12 through the network 18. The image storage unit 22 can store not only the images captured by a user through the use of the camera function of the user communication terminal 12, but also all images owned by the user such as images captured with a digital camera by the user.

The image evaluating unit 24 evaluates the degree of importance of each user image stored in the image storage unit 22 (the degree of importance for the user who is an owner of the image) on the basis of the information of the user communication terminal 12 such as the history or setting information acquired by the information acquiring unit 20, and calculates the evaluation value of the user image.

The application executing unit 26 executes an application using the user images stored in the image storage unit 22, and preferentially selects and uses an image having a high evaluation value, that is, an image having a high degree of importance on the basis of the evaluation values of the respective images calculated by the image evaluating unit 24.

Examples of the application executed by the application executing unit 26 include an electronic photo album or photo book preparing service for preferentially arranging a user image having a high degree of importance to prepare layout data thereof, a storage service for storing the user images in a storage of the network 16, elongating the storage period of a user image having a high degree of importance and deleting an unnecessary user image, and a viewer software for displaying a user image having a high degree of importance at the first (head) or displaying the user image in a large size.

Disclosure or non-disclosure of each image, uploading of each image to a server, or the like can also be automatically controlled on the basis of the degrees of importance (evaluation values) of the respective images through the use of the application executed by the application executing unit 26. For example, a viewer software which operates in the user communication terminal 12 may be used to control so as to display only an image having a high degree of importance or upload an image having a high degree of importance to a server for image disclosure in order to disclose the image to other users (to share the image with other users) through a network.

In this embodiment, the application executing unit 26 executes a preparation service for preparing layout data of an electronic photo album as the application.

The PC 16 is used to view or edit user images stored in the image storage unit 22 or images having been processed by the application executed in the application executing unit 26. The PC 16 has a communication function for downloading images from the image processing server 14 to the PC 16 or uploading the edited images from the PC 16 to the image processing server 14, an image viewing function, an image editing function, and the like.

In this embodiment, the PC 16 is used to download, view, and edit layout data of an electronic album prepared through the use of the electronic photo album preparing service executed by the application executing unit 26.

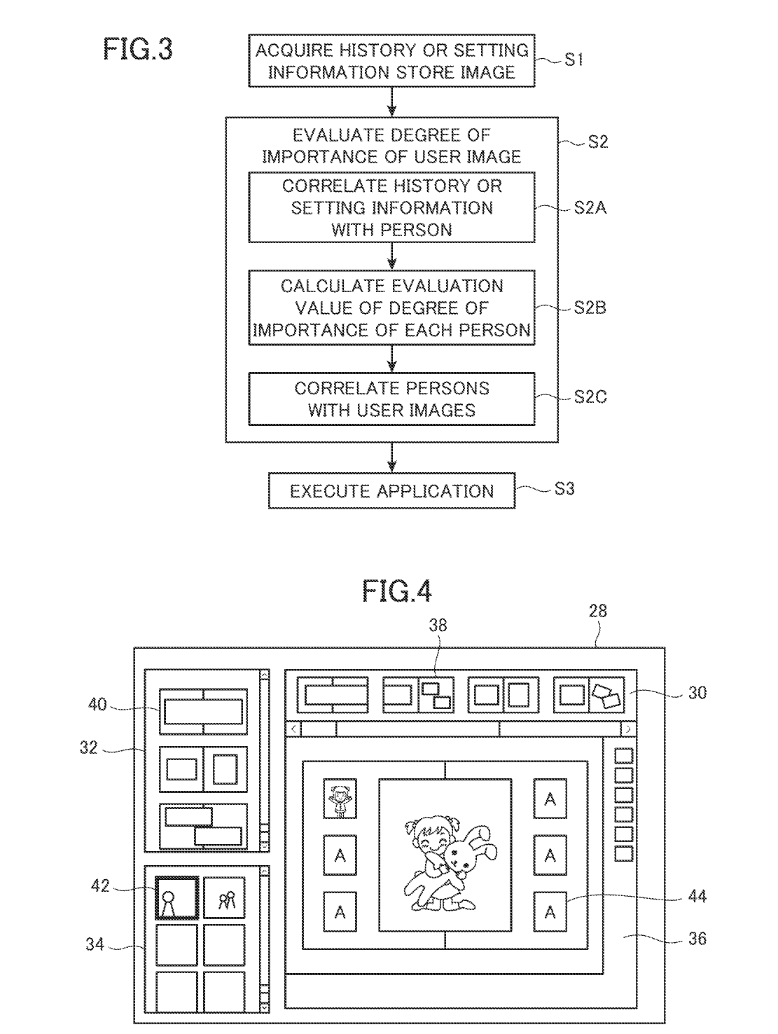

The operation of the image evaluating system 10 will be described according to an image evaluating method of the invention with reference to the flowchart shown in FIG. 3.

In the image evaluating system 10, the information of the user communication terminal 12 such as the history or setting information and images owned by a user are uploaded from the user communication terminal 12 to the image processing server 14 through the network 18.

In the image processing server 14, the information of the user communication terminal 12 such as the history or setting information uploaded from the user communication terminal 12 is acquired by the information acquiring unit 20 and the user images similarly uploaded are stored in the image storage unit 22 (step S1).

In evaluation of a degree of importance of a user image, the e-mail transmission and reception history is the most important for the user and the call outgoing and incoming history is the second most important. The history information of the user communication terminal 12 includes a number of executions of an act corresponding to the history information, an amount of information (such as data capacity of e-mail and duration of call), and a timing of execution, but the number of executions is the most important for the user. Therefore, if at least the number of executions of the e-mail transmission and reception is classified depending on respective communication partners (for example, friends), the degrees of importance of the respective user images can be evaluated.

Subsequently, the image evaluating unit 24 evaluates the degrees of importance of the respective user images stored in the image storage unit 22 and calculates the evaluation values on the basis of the information of the user communication terminal 12 such as the history or setting information acquired by the information acquiring unit 20 (step S2).

In the image evaluating unit 24, first, the information of the user communication terminal 12 such as the history or setting information is correlated with persons corresponding to the history or setting information by a first evaluating section (step S2A).

The information of the user communication terminal 12 such as the history or setting information can be correlated with persons extracted from a phone book or an e-mail address book stored in the user communication terminal 12. For example, phone numbers and persons are correlated with each other in the phone book, and e-mail addresses and persons are correlated with each other in the e-mail address book. Therefore, the e-mail history can be correlated with persons on the basis of the e-mail addresses, and the call history can be correlated with persons on the basis of the phone numbers.

Subsequently, a second evaluating section of the image evaluating unit 24 evaluates the degrees of importance of the respective persons and calculates the evaluation values thereof on the basis of the information such as the history or setting information correlated with the corresponding respective persons (step S2B).

In the image evaluating unit 24, first, history or setting to be evaluated, for example, the number of executions and the amounts of information of e-mail transmission and reception, are calculated for each person on the basis of the history and setting information correlated with the corresponding respective persons.

At this time, a person may be evaluated by using all of the past history information or may be evaluated, for example, by using only the history information in the latest limited period (within one month, within one year, and the like). The limited period may be determined depending on the relationship with the application executed by the application executing unit 26. For example, when an electronic photo album of a journey made half a year ago is prepared, the evaluation is performed by using only the history information in one week before and after half a year ago. Alternatively, all of the past history information may be used and the weight for only the period of one week before and after half a year ago may be increased.

The evaluation value of each person when it does not depend on a specific application is calculated by the following Expression (1).

Evaluation value=Σ(W_{—}i*f_{—}i(x,y)) (1)

Here, f_i(x, y) is a function representing a history to be evaluated, and x and y represent the number of executions and the amount of information, respectively. That is, f_i(x, y) represents the evaluation value of each history calculated from the number of executions and the amount of information.

W_i is a weight (weight coefficient) to be applied to each history, and the sum total of the product of f_i(x, y) and W_i for each history is the evaluation value of the degree of the importance for each person.

Moreover, it is preferable that f_i(x, y) be calculated by adding score correlated with the amount of information by the number of executions, and f_i(x, y) is expressed by the following Expression (2).

f_{—}i(x,y)=g(y_{—}1)+g(y_{—}2)+ . . . +g(y_{—}x) (2)

Here, g(y_j) (where j satisfies represents the score correlated with the amount of information for each execution. The correlating of the amount of information with the score can be performed, for example, using a function or a table.

As described above, examples of the history information includes an e-mail transmission and reception history, a call outgoing and incoming history, an image viewing history, and an application use history. In addition to these, the history information may include position information which can be expressed by the number of executions and the amount of information out of position information acquired through the use of the GPS function. For example, the number of visits to a home of a predetermined person, for example, a home of a friend, and the sojourn time can be calculated from the position information acquired through the use of the GPS function, and this history information may be used.

As the simplest evaluation, each person may be evaluated by making the score correlated with the amount of information a fixed value. That is, each person may be evaluated on the basis of only the number of executions.

Moreover, by combining for each history a fixed value with a metered value which is added depending on the amount of information, it is possible to perform a detailed setting depending on a user, for example, depending on whether the user is such a type of user who frequently calls friends or a type of user who has long talks on the phone with friends.

A specific example where an evaluation value is calculated using the e-mail transmission and reception history information and the call outgoing and incoming history information will be described below.

In this specific example, it is assumed that a person transmits five e-mails to, receives five e-mails from, and transmits one outgoing call lasting for 3 minutes and 20 seconds to person A, and receives two incoming calls lasting for about 30 seconds to give only necessary messages from person B. It is also assumed that the data capacity of the e-mails at the time of transmitting to person A is less than 4 KB, and the data capacity of the e-mails at the time of receiving from person A is about 40 KB with images attached thereto.

The weight (weight coefficient) for the individual history information of the user communication terminal 12 is as described in Table 1.

TABLE 1

| History information | Weight coefficient |
|---|---|
| e-mail transmission | 1 |
| e-mail reception | 0.5 |
| Outgoing call | 2 |
| Incoming call | 1 |

The relationship between the amount of information of each history (data capacity of e-mail and duration of call) and the score is as described in Table 2. In this specific example, the amount of information of each history is scored using a fixed value and a metered value which is added depending on the amount of information.

TABLE 2

| Amount of information | Fixed value | Metered value |
|---|---|---|
| Capacity of e-mail transmission | 100 | 10 every 4 KB |
| Capacity of e-mail reception | 100 | 5 every 4 KB |
| Duration of outgoing call | 100 | 10 every minute |
| Duration of incoming call | 100 | 5 every minute |

The following expressions can be used to calculate the evaluation value A of person A as 1135 points and the evaluation value B of person B as 200 points.

Evaluation Value A=(1*(100+100+100+100+100))+(0.5*((100+50)+(100+50)+(100+50)+(100+50)+(100+50)))+(2*(100+30))=1135

Evaluation Value B=1*(100+100)=200

When the image evaluating unit 24 uses the setting information of the user communication terminal 12, it is preferable to lower the evaluation value of a rejected person on the basis of e-mail rejection information or call rejection information.

On the other hand, when the evaluation value is calculated by the use of a specific application, for example, when an electronic photo album related to a journey made one month ago is prepared, the evaluation value may be calculated on the basis of only the history information in a given period before and after one month ago, or the history information in all periods may be used to apply a weight to the evaluation value related to the history information in a given period before and after one month ago, as described above.

Finally, in the image evaluating unit 24, the respective persons and user images are correlated by a third evaluating section (step S2C). Accordingly, the degrees of importance of the respective user images can be evaluated and the evaluation values thereof can be calculated, on the basis of the evaluation values of the respective persons. For example, by uniformly giving the same evaluation value, for example, the same evaluation value as the evaluation value of a person, to images including the same person, it is possible to calculate the evaluation value of each user image.

Since the evaluation values of the user images stored in the image storage unit 22 are thus calculated using the information of the user communication terminal 12 such as the history or setting information, it is possible to accurately evaluate the degrees of importance of the images owned by the user.

There are several methods for correlating persons with images owned by a user, but it is preferable that images and persons be correlated, for example, by performing person recognition processing which involves comparing the respective images with a reference image and recognizing who the persons included in the respective images are.

At this time, when face images of the persons correlated to the phone book of the user communication terminal 12 are attached, the person recognition processing on persons included in the respective images may be performed using the face images of the persons correlated to the phone book. Alternatively, the person recognition processing may be performed using several images designated by the user from among the images owned by the user. The correlation of the persons with the respective images may be designated by the user without using the person recognizing processing. Even when the user correlates the persons with the respective images, the correlation with all the images does not have to be performed. If several images are correlated, the other images can be automatically correlated through the use of person recognition processing in accordance with an instruction for correlation made by the user.

In any case, by presenting a candidate name of a person having a high evaluation value from the operation terminal (the user communication terminal 12 or the PC 16), or by performing face detection processing for detecting face regions of persons included in the respective images and presenting an image including a face even if it is not clear who the person is, it is possible to enhance the operation efficiency of the user and to improve convenience for the user.

The person recognition processing or the face detection processing is known image processing, and various kinds of person recognition processing or face detection processing can be used in the invention.

In the third evaluating section, plural image analysis processing may be performed on the respective user images, and the evaluation values of persons and the results of the image analysis processing performed on the respective user images may be combined to calculate the evaluation values of the respective user images.

For example, the results of the respective image analysis processing performed on the respective images may be scored, the total score of the results of the plural image analysis processing be calculated, and the evaluation values of persons and the total score be combined.

At least two processing of face detection processing, smiling face detection processing for detecting a smiling face of a person included in each image, person recognition processing, similar image decision processing for deciding a similar image, event classification processing for classifying images for each event on the basis of the capturing date and time of the respective images, and character recognition processing for recognizing characters included in each image may be performed as the image analysis processing and the results of these image analysis processing and the evaluation values of the persons be combined.

The information such as the history or setting information, the information on the evaluation value of each user image, and the like may be given as incidental information (tag information) of the image to image file by embedding such information in a header (for example, Exif information) of image data of each image or the image data itself as a digital watermark. Accordingly, when executing an application, the application executing unit 26 can acquire information on the evaluation values of images, that is, the degrees of importance of images, using the incidental information of each image, and can preferentially select an image having a high degree of importance to prepare an electronic photo album or the like.

Subsequently, an application using the user images stored in the image storage unit 22, for example, the electronic photo album preparing service in this embodiment, is executed by the application executing unit 26, and an image having a high degree of importance is preferentially selected and used on the basis of the evaluation values of the respective user images (step S3). For example, the layout data of an electronic photo album is prepared so as to display in a large size an image having a relatively high degree of importance out of plural images selected from the user images stored in the image storage unit 22.

Preparing and editing of the layout data of an electronic photo album will be described below.

FIG. 4 is a conceptual diagram illustrating an example of a screen for editing the layout data of an electronic photo album in a PC. The edit screen 28 shown in the drawing includes a page designating area 30, a template designating area 32, a candidate image display area 34, and an image editing area 36.

The page designating area 30 is an area in which a list of pages 38 to be edited is displayed in reduced size and which enables a user to designate (select) a necessary page through the use of an input unit such as a mouse, and is disposed in the right-upper area of the edit screen 28. Only a predetermined number of pages 38 are displayed in reduced size on the edit screen 28, but the range of the predetermined number of pages 38 displayed on the edit screen 28 can be changed through the use of a scroll bar. The same is true of the other areas.

The template designating area 32 is an area in which a list of templates 40 used in the page to be edited is displayed in reduced size and which enables a user to designate (select) a necessary template, and is disposed in the left-upper half area of the edit screen 28.

The candidate image display area 34 is an area in which a list of candidate images 42 designated (selected) by the user for use in the editing operation of image arrangement is displayed in reduced size, and is disposed in the left-lower half area of the edit screen 28. The candidate images 42 are images which are not disposed in the page to be edited out of the selected images. The user can simply perform the editing operation such as addition of an image and replacement of an image using the candidate images 42.

The image editing area 36 is an area in which images 44 arranged in the page designated for editing by the user in the page designating area 30 are displayed. The image editing area 36 is disposed in the right area of the edit screen 28.

The application executing unit 26 preferentially selects an image having a high degree of importance out of the user images stored in the image storage unit 22 on the basis of the evaluation values of the respective user images, and arranges (automatically lays out) the selected image in a page of an electronic photo album. In the example shown in FIG. 4, seven images of the selected images are arranged on two facing pages, and an image having the highest degree of importance out of the seven images is arranged at the center with a size larger than those of the other six images.

When the layout data of an electronic photo album is thus prepared, the layout data of the electronic photo album can be prepared by preferentially selecting and arranging images having high degrees of importance on the basis of the evaluation values of the respective user images.

The layout data of the electronic photo album prepared by the application executing unit 26 can be downloaded from the image processing server 14 to the PC 16 and can be viewed and edited in the PC 16.

In the PC 16, a user can designate a desired page 38 by clicking the desired page 38 in the list of pages 38 displayed in reduced size in the page designating area 30 of the edit screen 28, through the use of an input unit such as a mouse. When the user designates the desired page 38 from the list of pages 38, the designated page 38 is displayed in the image editing area 36 as a page to be edited.

After the images selected on the basis of the evaluation values of the respective user images are automatically laid out in the designated page of the electronic photo album, the user can edit the arrangement of images in each page by inputting an instruction through the use of the mouse or the like.

In the PC 16, an electronic book may be prepared from the layout data and downloaded to and viewed by the user communication terminal 12, or a photo book may be prepared from the layout data via a laboratory system not shown.

In the example shown in FIG. 1, the single user communication terminal 12 and the single PC 16 are representatively shown. However, the image evaluating system 10 may include plural user communication terminals 12 and PCs 16 which are used by users.

In the above-mentioned example, the user communication terminal 12, the image processing server 14, and the PC 16 are separately shown and described for the purpose of easy explanation. However, in view of functions, these plural functions may be concentrated on any one place or may be distributed to plural places. That is, the function of the image evaluating device may be mounted on the user communication terminal 12, or may be mounted on the image processing server 14, or may be mounted on a device, a server, or the like other than the user communication terminal 12 and the image processing server 14.

For example, when all functions of the image processing server 14 (that is, the image evaluating device) are mounted on the user communication terminal 12, the user images are stored in the user communication terminal 12, and the evaluation of the degree of importance of each user image and the preparation of layout data of an electronic photo album are performed in the user communication terminal 12. By thus mounting the function of the image processing server 14 on the user communication terminal 12, the image evaluating system 10 can be realized at low cost.

The PC 16 is not an essential element to the image evaluating system 10. When the function of the PC 16 is necessary, a smartphone having a function equivalent to the PC 16 in addition to a phone function may be used as the user communication terminal 12 instead of the PC 16. In this case, the viewing and editing of images can be performed in the user communication terminal 12. When the functions of the image processing server 14 and the PC 16 are mounted on the user communication terminal 12, the network 18 is not necessary.

On the other hand, by separately disposing the user communication terminal 12 and the image processing server 14 and uploading the information of the user communication terminal 12 such as the history or setting information and the user images to the image processing server 14 as shown in the example of FIGS. 1 and 2, it is possible to perform evaluation of a degree of importance of each user image or execution of an application at a high speed by the use of the image processing server 14 having larger processing capability than that of the user communication terminal 12.

In the PC 16, the function of the image processing server 14, that is, at least one of evaluation of a degree of importance of each user image and execution of an application may be performed.

The image evaluating method according to the invention can be performed by the use of a program causing a computer to perform the steps of the image evaluating method. For example, this program can be provided in a state where it is recorded on a computer-readable recording medium.

The basic description of the invention has been made above. While the invention has been described in detail, the invention is not limited to the above-described embodiments but can be improved or modified in various forms without departing from the gist of the invention.

What is claimed is:

1. An image evaluating device comprising:
an information acquiring unit that acquires history information of a user communication terminal having a camera function;
an image storage unit that stores images at least a part of which is captured by the use of the camera function of the user communication terminal; and
an image evaluating unit that calculates evaluation values of the respective images stored in the image storage unit based on the history information acquired by the information acquiring unit.

2. The image evaluating device according to claim 1, wherein the image evaluating unit comprises a first evaluating section that correlates the history information with persons corresponding to the history information, a second evaluating section that calculates evaluation values of the respective persons based on the history information correlated with the corresponding respective persons by the first evaluating section, and a third evaluating section that correlates the respective persons with the respective images stored in the image storage unit and that calculates the evaluation values of the respective images stored in the image storage unit based on the evaluation values of the respective persons calculated by the second evaluating section.

3. The image evaluating device according to claim 2, wherein the second evaluating section calculates a number of executions and an amount of information of an act corresponding to the history information from the history information and calculates the evaluation values of the respective persons from the number of executions and the amount of information.

4. The image evaluating device according to claim 2, wherein the second evaluating section calculates, from the history information, a number of executions and an amount of information in a given period specified by a user of the user communication terminal and calculates the evaluation values of the respective persons from the number of executions and the amount of information.

5. The image evaluating device according to claim 2, wherein the second evaluating section calculates, from the history information, a number of executions and an amount of information in an entire period by weighting a given period specified by a user of the user communication terminal and calculates the evaluation values of the respective persons from the number of executions and the amount of information.

6. The image evaluating device according to claim 3, wherein the history information is information on transmission and reception of e-mails, and the second evaluating section calculates a number of times of transmission and reception and data capacity of the e-mails as the number of executions and the amount of information, respectively, from the information on the transmission and reception of the e-mails and calculates the evaluation values of the respective persons from the number of times of transmission and reception and the data capacity of the e-mails.

7. The image evaluating device according to claim 3, wherein the history information is information on outgoing and incoming calls, and the second evaluating section calculates numbers of outgoing and incoming calls and a duration of the calls as the number of executions and the amount of information, respectively, from the information on the outgoing and incoming calls and calculates the evaluation values of the respective persons from the numbers of outgoing and incoming calls and the duration of the calls.

8. The image evaluating device according to claim 3, wherein the history information is information on display of the images, and the second evaluating section calculates a number of times of display and a display time of the respective images as the number of executions and the amount of information, respectively, from the information on the display of the images and calculates the evaluation values of the respective persons from the number of times of display and the display time of the images.

9. The image evaluating device according to claim 3, wherein the user communication terminal has a GPS function for acquiring position information of the user communication terminal, the history information is information on visit to a home of a person calculated from the position information, and the second evaluating section calculates a number of visits and a sojourn time of visit to the home of the person as the number of executions and the amount of information, respectively, from the information on the visit to the home of the person and calculates the evaluation values of the respective persons from the number of visits and the sojourn time of visit to the home of the person.

10. The image evaluating device according to claim 1, wherein the information acquiring unit further acquires setting information of the user communication terminal, and the image evaluating unit evaluates the respective images stored in the image storage unit based on the setting information of the user communication terminal acquired by the information acquiring unit in addition to the history information.

11. The image evaluating device according to claim 10, wherein the setting information of the user communication terminal includes at least one of e-mail rejection information and call rejection information.

12. The image evaluating device according to claim 2, wherein the third evaluating section performs a plurality of image analysis processing on the respective images stored in the image storage unit, combines the evaluation values of the respective persons calculated by the second evaluating section and results of the image analysis processing performed on the respective images stored in the image storage unit, and calculates the evaluation values of the respective images stored in the image storage unit.

13. The image evaluating device according to claim 12, wherein the third evaluating section performs at least two of face detection processing for detecting a face region of a person included in each image, smiling face detection processing for detecting a smiling face of a person included in each image, person recognition processing for recognizing who a person included in each image is, similar image decision processing for deciding a similar image, event classification processing for classifying respective images for each event, and character recognition processing for recognizing characters included in each image, as the image analysis processing.

14. The image evaluating device according to claim 12, wherein the third evaluating section scores the results of the respective image analysis processing performed on the respective images stored in the image storage unit, calculates a total score of the results of the plurality of image analysis processing, combines the evaluation values of the respective persons calculated by the second evaluating section and the total score, and calculates the evaluation values of the respective images stored in the image storage unit.

15. The image evaluating device according to claim 1, wherein the image evaluating unit adds information of the evaluation values of the respective images to image files of the respective images as incidental information.

16. The image evaluating device according to claim 1, further comprising an application executing unit that executes an application using the images stored in the image storage unit,
wherein the application executing unit preferentially selects and uses an image having a high evaluation value based on the evaluation values of the respective images calculated by the image evaluating unit.

17. The image evaluating device according to claim 16, wherein the application executing unit executes a preparation service for preparing layout data of an electronic photo album as the application.

18. An image evaluating system comprising:
the user communication terminal; and
the image evaluating device according to claim 1 that is connected to the user communication terminal through a network.

19. A user communication terminal having a camera function, comprising:
an information acquiring unit that acquires history information of the user communication terminal;
an image storage unit that stores images at least a part of which is captured by the use of the camera function of the user communication terminal;
an image evaluating unit that calculates evaluation values of the respective images stored in the image storage unit based on the history information acquired by the information acquiring unit; and
an application executing unit that executes an application using the images stored in the image storage unit,
wherein the application executing unit preferentially selects and uses an image having a high evaluation value based on the evaluation values of the respective images calculated by the image evaluating unit.

20. An image processing server connected to a user communication terminal having a camera function through a network, comprising:
an information acquiring unit that acquires history information of the user communication terminal;
an image storage unit that stores images at least a part of which is captured by the use of the camera function of the user communication terminal;
an image evaluating unit that calculates evaluation values of the respective images stored in the image storage unit based on the history information acquired by the information acquiring unit; and
an application executing unit that executes an application using the images stored in the image storage unit,
wherein the application executing unit preferentially selects and uses an image having a high evaluation value based on the evaluation values of the respective images calculated by the image evaluating unit.

21. An image evaluating method comprising:
an information acquiring step of acquiring history information of a user communication terminal having a camera function;
an image storing step of storing images at least a part of which is captured by the use of the camera function of the user communication terminal; and
an image evaluating step of calculating evaluation values of the respective images stored in the image storing step based on the history information acquired in the information acquiring step.

22. A non-transitory computer-readable recording medium having recorded thereon a program for causing a computer to perform the respective steps of the image evaluating method according to claim 21.
